(19) United States
(12) Patent Application Publication
(10) Pub. No.: US 2026/0070511 A1
(43) Pub. Date: Mar. 12, 2026

(54) MOVING BODY CONTROL SYSTEM AND MOVING BODY CONTROL METHOD

(71) Applicant: TOYOTA JIDOSHA KABUSHIKI KAISHA, Toyota-shi (JP)

(72) Inventor: Kazuhiko UEDA, Cyofu-shi (JP)

(73) Assignee: TOYOTA JIDOSHA KABUSHIKI KAISHA, Toyota-shi (JP)

(21) Appl. No.: 19/298,173

(22) Filed: Aug. 12, 2025

(30) Foreign Application Priority Data
Sep. 9, 2024 (JP) 2024-154590

(51) Int. Cl. B60R 25/102; B60W 30/06

(52) U.S. Cl. CPC B60R 25/102; B60W 30/06

(57) ABSTRACT

A moving body control system is configured to control a moving body having a function of operating in accordance with a remote instruction in a predetermined area. The moving body control system includes a management system and a control device mounted on the moving body. The control device is configured to execute a first verification process of determining whether or not a suspicion of unauthorized activation of the control device exists, and when the suspicion of the unauthorized activation exists, request the management system to execute a second verification process of finally determining whether or not the suspicion of the unauthorized activation is valid based on a criterion different from a criterion of the first verification process.

### CROSS-REFERENCE TO RELATED APPLICATION

This application claims priority to Japanese Patent Application No. 2024-154590 filed on September 9, 2024. The disclosure of the above-identified application, including the specification, drawings, and claims, is incorporated by reference herein in its entirety.

### BACKGROUND

### Technical Field

The present disclosure relates to a moving body control system and a moving body control method.

### Description of Related Art

Japanese Unexamined Patent Application Publication No. 2023-148463 (JP 2023-148463 A) discloses a moving body control system that controls a moving body having a function of operating in accordance with a remote instruction in a predetermined area. The moving body control system executes a remote instruction verification process of determining whether or not the remote instruction received by the moving body is valid, and an operation restriction process of restricting at least a part of operation of the moving body without following the remote instruction when the remote instruction received by the moving body is invalid.

### SUMMARY

When an in-vehicle system (moving body) executes a remote instruction verification process described in JP 2023-148463 A, large processing load can be applied to the moving body. On the other hand, when a management system executes the remote instruction verification process, and when it can be determined on the moving body side that the remote instruction is valid, useless communication occurs between the moving body and the management system. It is therefore desired that the moving body and the management system can cooperate to efficiently execute determination as to whether or not a suspicious of unauthorized access to the moving body is valid.

A moving body control system according to a first aspect of the present disclosure is configured to control a moving body having a function of operating in accordance with a remote instruction in a predetermined area. The moving body control system includes a management system and a control device. The management system is configured to legitimately generate the remote instruction. The control device is mounted on the moving body and configured to cause the moving body to operate in accordance with the legitimate remote instruction from the management system. The control device is configured to execute a first verification process of determining whether or not a suspicion of unauthorized activation of the control device exists. Then, when the suspicion of the unauthorized activation exists, the control device is configured to request the management system to execute a second verification process of finally determining whether or not the suspicion of the unauthorized activation is valid based on a criterion different from a criterion of the first verification process.

In the moving body control system according to the first aspect of the present disclosure, the remote instruction may include an activation instruction that remotely activates the control device, and the first verification process may include determining whether or not the activation instruction received by the control device complies with a predefined format, and when the activation instruction does not comply with the predefined format, determining that the suspicion of the unauthorized activation exists.

In the moving body control system according to the first aspect of the present disclosure, the first verification process may include determining whether or not activation of the control device not following a predefined activation sequence has been detected, and when the activation of the control device not following the predefined activation sequence has been detected, determining that the suspicion of the unauthorized activation exists.

In the moving body control system according to the first aspect of the present disclosure, the remote instruction may include an activation instruction that remotely activates the control device, and the second verification process may include determining whether or not the management system has actually transmitted the activation instruction received by the moving body, and when the management system has not actually transmitted the activation instruction to the moving body, finally determining that the suspicion of the unauthorized activation is valid.

In the moving body control system according to the first aspect of the present disclosure, when the second verification process finally determines that the suspicion of the unauthorized activation is valid, the management system may be configured to request a mobile network operator to stop information transmission to all moving bodies managed by the management system from an electric communication number used for transmission of the activation instruction related to the suspicion of the unauthorized activation under conditions that a transmission stop condition is satisfied, and the transmission stop condition may be a condition that the electric communication number has been used for an unauthorized activation instruction of control devices of a plurality of moving bodies including the control device of the moving body or a condition that the electric communication number has been used a plurality of times within a predetermined period for an unauthorized activation instruction of the control device of the moving body.

In the moving body control system according to the first aspect of the present disclosure, the remote instruction may include an activation instruction that remotely activates the control device, and the second verification process may include acquiring position information of the moving body, determining whether or not the moving body is present in the predetermined area when the control device receives the activation instruction by comparing map information in which a position of the predetermined area is registered and the position information of the moving body, and when the moving body is not present in the predetermined area when the control device receives the activation instruction, finally determining that the suspicion of the unauthorized activation is valid.

In the moving body control system according to the first aspect of the present disclosure, the remote instruction may include an activation instruction that remotely activates the control device, the moving body and a communication device provided in the predetermined area may be configured to perform communication in accordance with a specific communication scheme, and the second verification process may include determining whether or not communication is established between the moving body and the communication device, and when the communication is not established between the moving body and the communication device, finally determining that the moving body is not present in the predetermined area when the moving body receives the activation instruction and the suspicion of the unauthorized activation is valid.

In the moving body control system according to the first aspect of the present disclosure, the control device may be configured to be activated after first authentication is completed, and then, second authentication is completed, and the first authentication may be authentication regarding mode change, and the second authentication may be authentication regarding activation of the control device.

A moving body control method according to a second aspect of the present disclosure is a method for controlling a moving body having a function of operating in accordance with a remote instruction in a predetermined area. The moving body control method includes causing the control device to execute a first verification process of determining whether or not a suspicion of unauthorized activation of the control device exists, and when the suspicion of the unauthorized activation exists, requesting the management system to execute a second verification process of finally determining whether or not the suspicion of the unauthorized activation is valid based on a criterion different from a criterion of the first verification process. The control device configured to cause the moving body to operate in accordance with a legitimate remote instruction from the management system configured to legitimately generate the remote instruction is mounted on the moving body.

According to the present disclosure, only when it is determined on the moving body side that a suspicion of unauthorized activation of the control device exists, the control device of the moving body requests the management system to execute the second verification process of finally determining whether or not the suspicion of the unauthorized activation is valid based on the criterion different from the criterion of the first verification process. This makes it possible for the moving body and the management system to cooperate to efficiently execute determination as to whether or not the suspicion of the unauthorized activation of the moving body is valid.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 is a conceptual diagram for explaining outline of a vehicle according to an embodiment;

FIG. 2 is a block diagram for explaining outline of an in-vehicle system mounted on the vehicle;

FIG. 3 is a conceptual diagram for explaining automated valet parking;

FIG. 4 is a conceptual diagram for explaining a mobility service in a predetermined area;

FIG. 5 is a block diagram illustrating a configuration example of a vehicle control system according to the embodiment;

FIG. 6 is a flowchart indicating an example of a process on a vehicle side related to verification and countermeasures of a suspicion of unauthorized activation according to the embodiment;

FIG. 7 is a flowchart indicating a specific example of a process of step S102;

FIG. 8 is a flowchart indicating a specific example of a process of step S106;

FIG. 9 is a flowchart indicating an example of a process on a management system side related to verification and countermeasures of a suspicion of unauthorized activation according to the embodiment;

FIG. 10 is a flowchart indicating a first specific example of a second verification process;

FIG. 11A is a conceptual diagram for explaining a second specific example of the second verification process;

FIG. 11B is a flowchart for explaining the second specific example of the second verification process;

FIG. 12 is a sequence diagram indicating a specific example of processing flow related to activation of a control device based on a legitimate activation instruction;

FIG. 13 is a sequence diagram indicating a specific example of processing flow related to activation of the control device when an activation instruction that is suspected to be unauthorized remote activation is received;

FIG. 14 is a sequence diagram indicating a specific example of processing flow related to activation of the control device when an activation instruction that is suspected to be unauthorized activation operation is received; and

FIG. 15 is a flowchart indicating a modification of the process on the vehicle side related to verification and countermeasures of the suspicion of unauthorized activation according to the embodiment.

### DETAILED DESCRIPTION OF EMBODIMENTS

### Moving Body Operating in Accordance with Remote Instruction

### Outline

An embodiment of the present disclosure will be described with reference to the accompanying drawings.

A moving body having a function of operating in accordance with a remote instruction will be considered. Examples of the moving body include a vehicle, a robot, and the like. As one example, in the following description, a case will be considered where the moving body is a vehicle. When the description is generalized, the “vehicle” in the following description is read as the “moving body”.

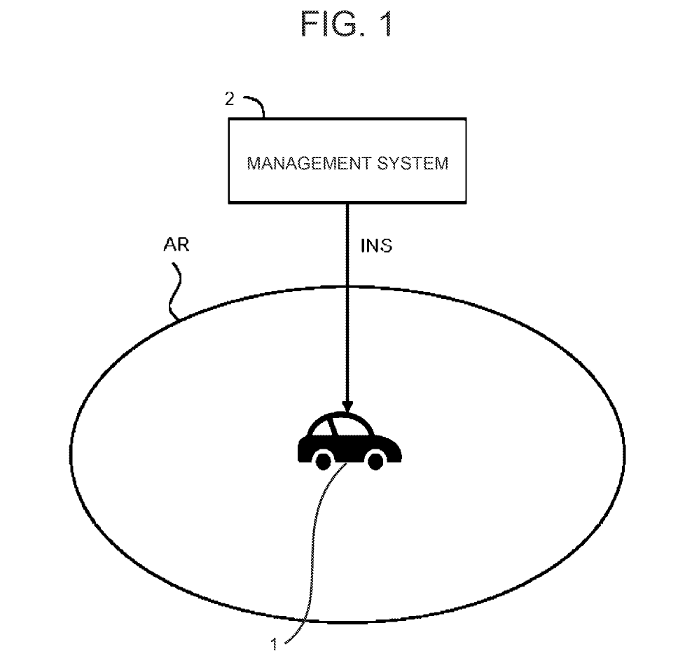

FIG. 1 is a conceptual diagram for explaining outline of a vehicle 1 according to the present embodiment. The vehicle 1 has a function of operating in accordance with a remote instruction INS. In particular, the vehicle 1 has a function of operating in accordance with the remote instruction INS in a predetermined area AR.

The predetermined area AR is, for example, an area in which the vehicle 1 can autonomously drive. In this case, the vehicle 1 autonomously drives in accordance with the remote instruction INS in the predetermined area AR. As another example, the predetermined area AR may be an area in which a service utilizing the vehicle 1 is to be provided. In this case, the vehicle 1 provides a service in accordance with the remote instruction INS in the predetermined area AR. Various examples of the predetermined area AR will be described later.

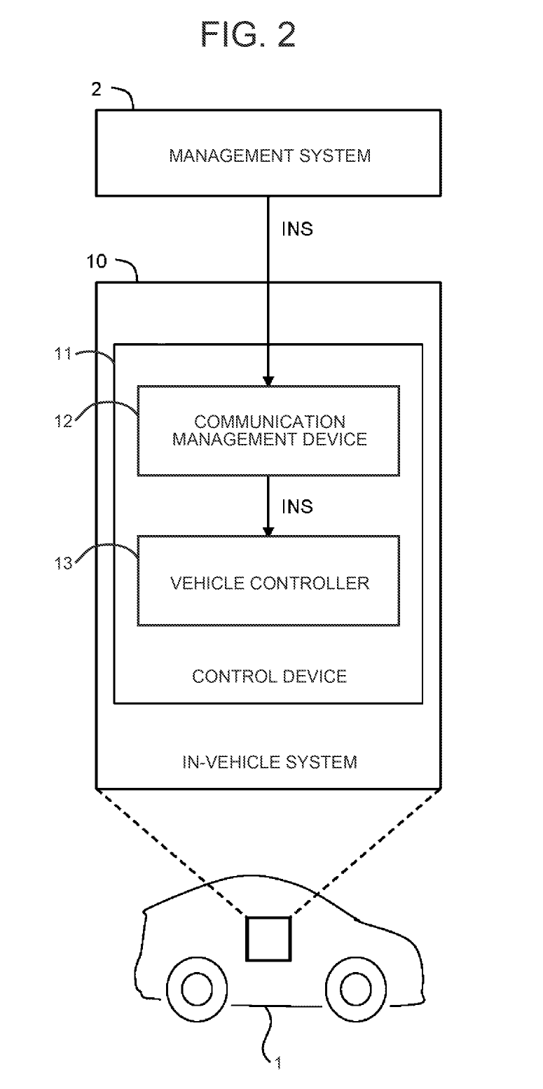

The remote instruction INS includes an “activation instruction INS-A” that remotely activates a control device 11 (see FIG. 2) of the vehicle 1. Further, the remote instruction INS includes an instruction to cause the activated control device 11 (more specifically, a vehicle controller 13 (see FIG. 2)) to power on or off (turn on or off a main power supply of) the vehicle 1. “Powering on the vehicle 1” means bringing the vehicle 1 into an operable state. For example, powering on the vehicle 1 includes starting supply of electric power to various devices mounted on the vehicle 1. Further, powering on the vehicle 1 includes turning on an ignition of the vehicle 1. On the other hand, “powering off the vehicle 1” means bringing the vehicle 1 into an inoperable state. For example, powering off the vehicle 1 includes turning off the ignition of the vehicle 1. As another example, powering off the vehicle 1 may include stopping supply of electric power to various devices mounted on the vehicle 1. Note that even when the vehicle 1 is powered off (the main power supply is turned off), the control device 11 is mounted so as to be operable by an auxiliary power supply different from the main power supply. Thus, even after the vehicle 1 is powered off, at least a function of the control device 11 (more specifically, a communication management device 12 (see FIG. 2)) of receiving the remote instruction INS is activated. Thus, even after the power-off, the vehicle 1 can receive the remote instruction INS that gives an instruction to be powered on and can be automatically powered on in accordance with the remote instruction INS.

As another example, the remote instruction INS may instruct the vehicle 1 to perform at least one of steering, acceleration or deceleration. As still another example, the remote instruction INS may instruct the vehicle 1 to autonomously drive. As yet another example, the remote instruction INS may give an instruction to recognize a situation around the vehicle 1 using a recognition sensor mounted on the vehicle 1. As another example, the remote instruction INS may give an instruction to lock or unlock a door of the vehicle 1.

The remote instruction INS is generated by the management system 2. The management system 2 manages at least the vehicle 1 in the predetermined area AR. The management system 2 may manage the predetermined area AR. The management system 2 may manage a service provided by utilizing the vehicle 1 in the predetermined area AR. The vehicle 1 and the management system 2 can perform communication with each other. The management system 2 transmits the remote instruction INS to the vehicle 1 in the predetermined area AR as necessary. The vehicle 1 in the predetermined area AR receives the remote instruction INS transmitted from the management system 2 and operates in accordance with the received remote instruction INS. The management system 2 is, for example, implemented by a management server on cloud. The management system 2 may be constituted with a plurality of servers that performs distributed processes.

FIG. 2 is a block diagram for explaining outline of an in-vehicle system 10 mounted on the vehicle 1. The in-vehicle system 10 includes the control device 11. The control device 11, which is a computer that causes the vehicle 1 to operate in accordance with the remote instruction INS from the management system 2, includes a communication management device 12 and the vehicle controller 13.

The communication management device 12 receives the remote instruction INS transmitted from the management system 2. When the communication management device 12 receives the remote instruction INS, the vehicle controller 13 controls the vehicle 1 in accordance with the received remote instruction INS. For example, control of the vehicle 1 includes powering on or off the vehicle 1. As another example, control of the vehicle 1 includes control of traveling (steering, acceleration and deceleration) of the vehicle 1. As still another example, control of the vehicle 1 may include autonomous driving control of the vehicle 1. As yet another example, control of the vehicle 1 may include recognizing a situation around the vehicle 1 using the recognition sensor mounted on the vehicle 1. As another example, control of the vehicle 1 may include locking or unlocking the door of the vehicle 1. As still another example, control of the vehicle 1 may include turning on or off a light (for example, a headlight, a hazard lamp) of the vehicle 1. As yet another example, control of the vehicle 1 may include blasting a horn of the vehicle 1.

An example of the vehicle 1 that operates in accordance with the remote instruction INS in the predetermined area AR will be described below.

### Automated Valet Parking

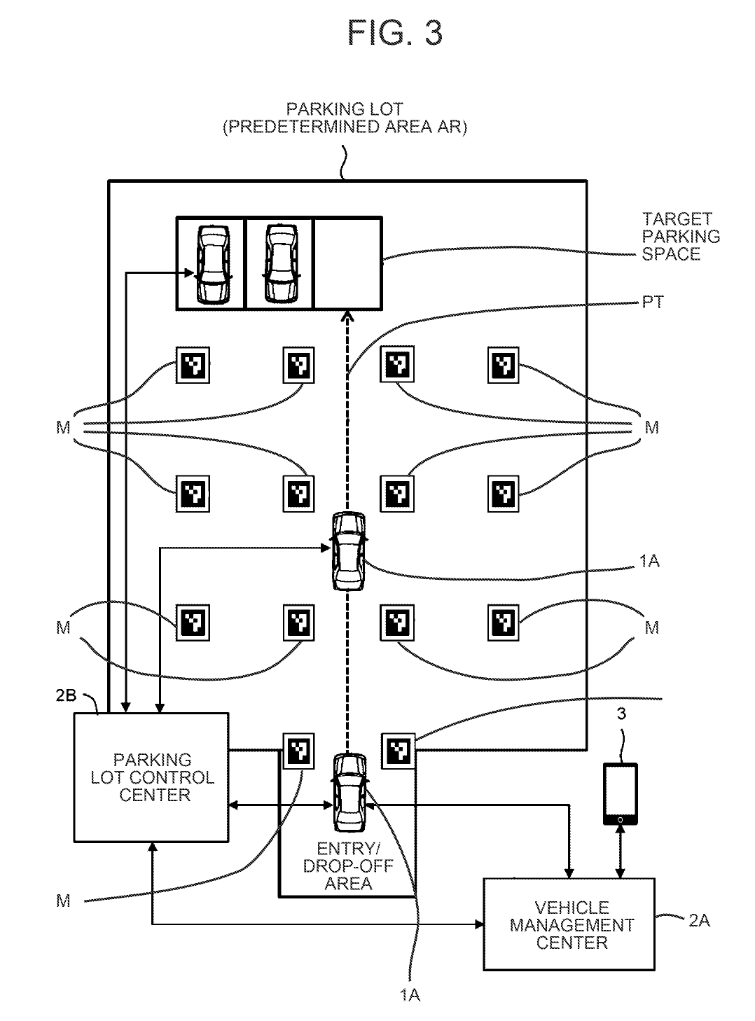

FIG. 3 is a conceptual diagram for explaining automated valet parking (AVP). In the present example, the predetermined area AR is a parking lot. The parking lot may be indoor or may be outdoor. An AVP vehicle 1A is the vehicle 1 that supports automated valet parking in the parking lot. The AVP vehicle 1A is able to autonomously drive at least in the parking lot. More specifically, the AVP vehicle 1A includes a recognition sensor (for example, a camera) for recognizing a surrounding situation. The AVP vehicle 1A autonomously drives in the parking lot while recognizing the surrounding situation using the recognition sensor.

As illustrated in FIG. 3, a plurality of landmarks (markers) M arranged in the parking lot may be used to implement the above-described autonomous driving. Identification information is provided to the landmarks M. For example, the AVP vehicle 1A acquires an image indicating a situation around the AVP vehicle 1A using the camera and recognizes the landmark M based on the image. The AVP vehicle 1A is able to recognize an entry area based on a result of recognition of the landmark M. Further, the AVP vehicle 1A performs “localization process (self-position estimation process, localization)” that estimates a position of the AVP vehicle 1A in the parking lot with high accuracy based on the result of recognition of the landmark M. A target path PT is a path of movement from the entry area to a target parking space allocated to the AVP vehicle 1A. The AVP vehicle 1A performs autonomous driving so as to follow the target path PT based on the position of the AVP vehicle 1A estimated by the localization process and the target path PT. This enables the AVP vehicle 1A to autonomously move from the entry area to the target parking space.

The management system 2 manages the automated valet parking in the parking lot. The management system 2 is capable of communicating with vehicles including the AVP vehicle 1A in the parking lot. For example, the management system 2 issues the remote instruction INS to the AVP vehicle 1A. For example, the remote instruction INS gives an instruction to power on or off the AVP vehicle 1A. As another example, the remote instruction INS gives an instruction to start autonomous driving. The management system 2 may provide map information of the landmarks M in the parking lot to the AVP vehicle 1A. The management system 2 may remotely operate the AVP vehicle 1A in the parking lot.

As illustrated in FIG. 3, the management system 2 may include a vehicle management center 2A and a parking lot control center 2B. The parking lot control center 2B is provided for each parking lot. For example, the parking lot control center 2B grasps a situation of the parking lot, allocates a parking space to the AVP vehicle 1A, generates the target path PT, provides the AVP vehicle 1A with the target path PT, and the like.

The vehicle management center 2A controls parking lot control centers 2B of a large number of parking lots. For that purpose, the vehicle management center 2A communicates with each parking lot control center 2B to collect various kinds of information and provide various kinds of information. Further, the vehicle management center 2A manages the AVP vehicle 1A and transmits the remote instruction INS to the AVP vehicle 1A as necessary. Still further, the vehicle management center 2A manages users and reservations of an automated valet parking service. The vehicle management center 2A may communicate with a user terminal 3 operated by a user of the automated valet parking service. Member information of the user is registered in advance in the vehicle management center 2A.

In addition, the AVP vehicle 1A receives the remote instruction INS that gives an instruction to be powered on from the management system 2 upon entry into or check-out from the parking lot. The AVP vehicle 1A is automatically powered on in accordance with the received remote instruction INS and then starts autonomous driving in the parking lot. The management system 2 may communicate with the AVP vehicle 1A and remotely control autonomous driving of the AVP vehicle 1A. Further, when parking of the AVP vehicle 1A in the target parking space is completed upon entry, the management system 2 communicates with the AVP vehicle 1A to transmit the remote instruction INS that gives an instruction to power off the AVP vehicle 1A. The AVP vehicle 1A is automatically powered off in accordance with the received remote instruction INS.

### Mobility Service

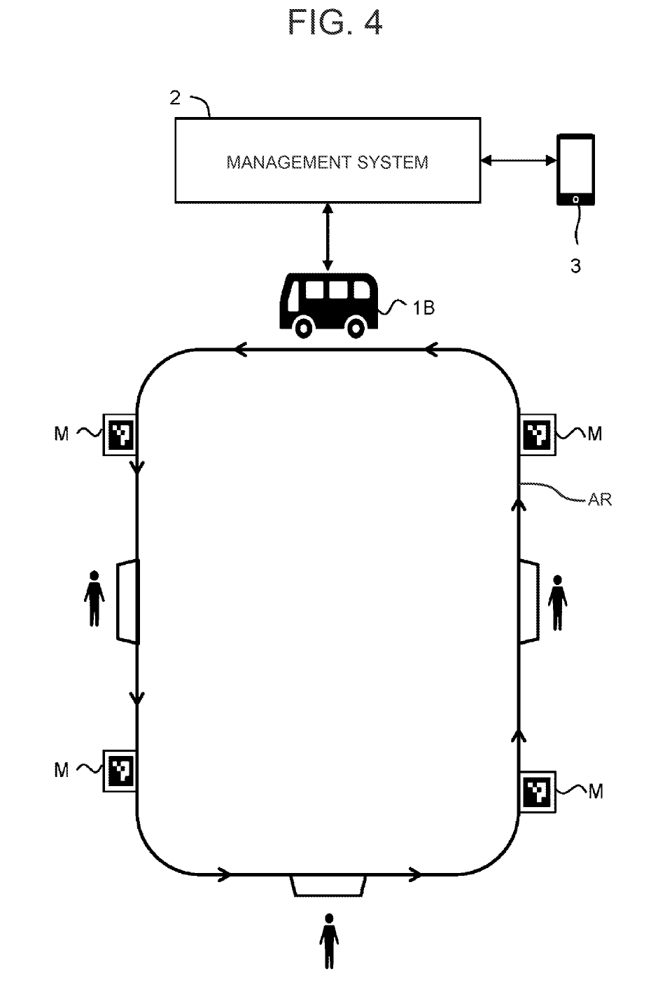

FIG. 4 is a conceptual diagram for explaining a mobility service in the predetermined area AR. The predetermined area AR is an area in which the mobility service is to be provided. For example, the predetermined area AR is a city such as a “smart city” or a part of the city.

A mobility service vehicle 1B is the vehicle 1 for providing the mobility service in the predetermined area AR. Examples of the mobility service vehicle 1B include a bus, a taxi, a shared car, and the like. Examples of the bus include a route bus, a sightseeing bus, an on-demand bus, a semi-demand bus, and the like.

For example, the mobility service vehicle 1B performs autonomous driving in the predetermined area AR. More specifically, the mobility service vehicle 1B includes a recognition sensor (for example, a camera) for recognizing a surrounding situation. The mobility service vehicle 1B performs autonomous driving in the predetermined area AR while recognizing the surrounding situation using the recognition sensor.

Landmarks (markers) M for the localization process may be arranged in the predetermined area AR. The mobility service vehicle 1B uses a camera to acquire an image indicating a situation around the mobility service vehicle 1B and recognizes the landmark M based on the acquired image. The mobility service vehicle 1B performs the localization process based on a result of recognition of the landmark M to estimate a self-position in the predetermined area AR. The mobility service vehicle 1B performs autonomous driving based on the estimated self-position.

The management system 2 manages the mobility service and each mobility service vehicle 1B in the predetermined area AR. The management system 2 is capable of communicating with each mobility service vehicle 1B in the predetermined area AR. For example, the management system 2 communicates with each mobility service vehicle 1B to collect information on a position and a state of each mobility service vehicle 1B. In addition, the management system 2 issues the remote instruction INS to the mobility service vehicle 1B as necessary. For example, the remote instruction INS gives an instruction to power on or off the mobility service vehicle 1B. As another example, the remote instruction INS may remotely instruct the mobility service vehicle 1B to perform at least one of steering, acceleration or deceleration. Further, the management system 2 manages users and reservations of the mobility service. The management system 2 may communicate with a user terminal 3 operated by a user of the mobility service.

### Other Examples

The moving body may be a robot that autonomously drives in the predetermined area AR. For example, the moving body is a logistics robot that automatically transports a package in the predetermined area AR such as a city, a stockroom and a factory. As another example, the moving body may be a work robot that performs predetermined work in the predetermined area AR such as a stockroom and a factory.

### System Configuration Example

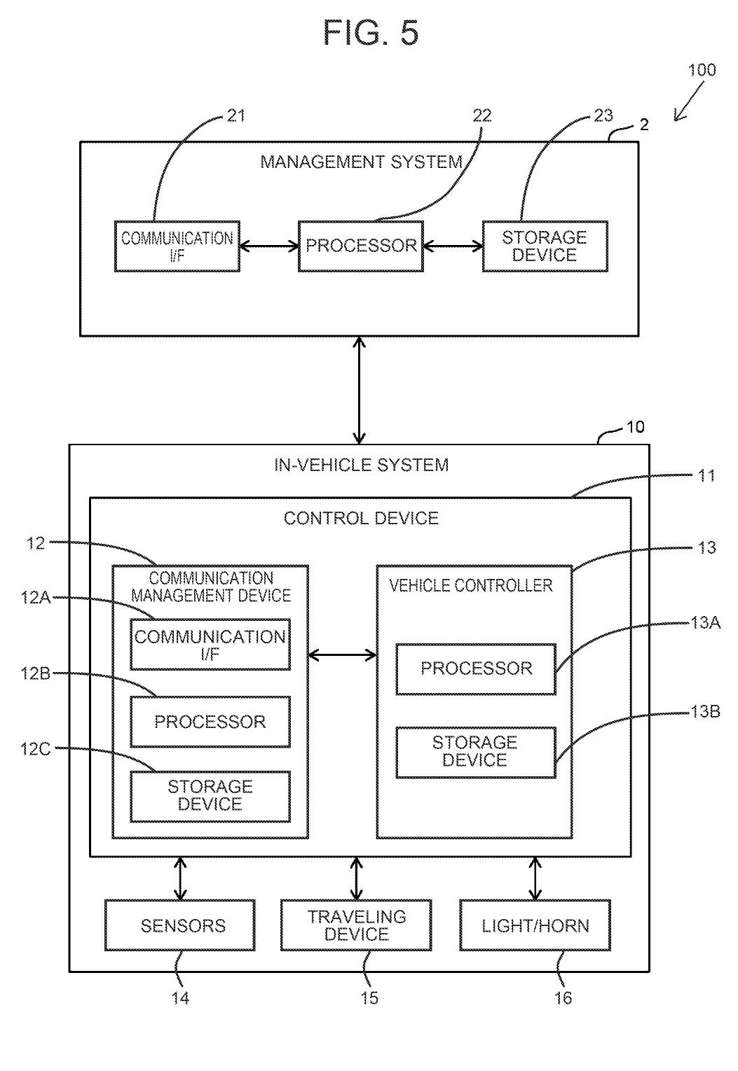

FIG. 5 is a block diagram illustrating a configuration example of the vehicle control system 100 according to the present embodiment. The vehicle control system 100 (moving body control system) includes the in-vehicle system 10 and the management system 2.

### In-Vehicle System

The in-vehicle system 10 is mounted on the vehicle 1 and includes, for example, sensors 14, a traveling device 15, and a light/horn 16 as well as the control device 11.

The communication management device 12 included in the control device 11 manages communication between outside of the vehicle 1 and the vehicle 1. The communication management device 12 includes a communication interface (communication I/F) 12A, one or a plurality of processors 12B (hereinafter, simply referred to as a processor 12B), and one or a plurality of storage devices 12C (hereinafter, simply referred to as a storage device 12C).

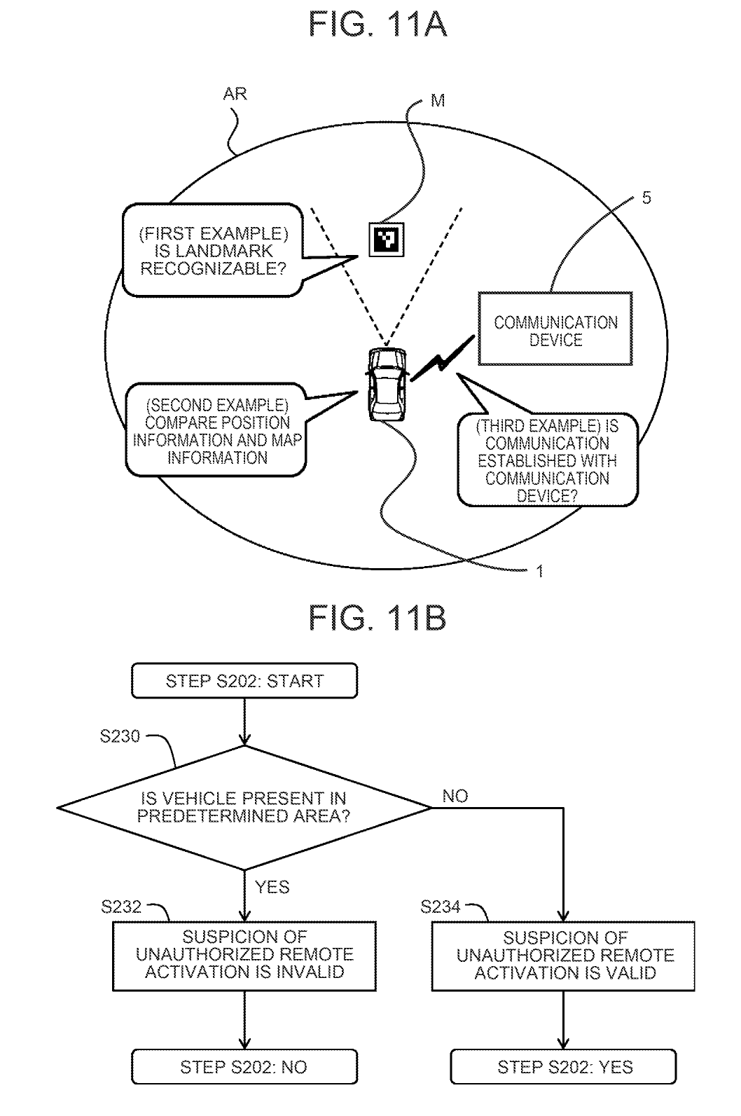

The communication I/F 12A is an interface for communicating with a device or a system (for example, the management system 2) outside the vehicle 1 to transmit/receive information. For example, the communication I/F 12A includes various kinds of equipment such as equipment for connecting to a mobile communication network, equipment for connecting to the Internet, and equipment for connecting to peripheral devices (for example, a communication device 5 illustrated in FIG. 11A) through a wireless LAN.

The processor 12B executes various kinds of processing. Examples of the processor 12B include a central processing unit (CPU), a graphics processing unit (GPU), an application specific integrated circuit (ASIC), a field-programmable gate array (FPGA), and the like. The processor 12B can be also referred to as a “circuitry” or a “processing circuitry”. The “circuitry” is hardware programmed to implement the described functions or hardware that executes functions. The storage device 12C stores various kinds of information. Examples of the storage device 12C include a volatile memory, a non-volatile memory, a hard disk drive (HDD), a solid state drive (SSD), and the like. The processor 12B reads various kinds of information from the storage device 12C and stores various kinds of information in the storage device 12C. Functions of the communication management device 12 are implemented by cooperation of the processor 12B that executes a communication management program and the storage device 12C. The communication management program is stored in the storage device 12C. Alternatively, the communication management program may be recorded in a computer-readable recording medium.

The vehicle controller 13 included in the control device 11 controls the vehicle 1 in accordance with the remote instruction INS. The vehicle controller 13 includes one or a plurality of processors 13A (hereinafter, simply referred to as a processor 13A) and one or a plurality of storage devices 13B (hereinafter, simply referred to as a storage device 13B). A configuration example of the processor 13A is the same as the configuration example of the processor 12B described above. Further, a configuration example of the storage device 13B is the same as the configuration example of the storage device 12C described above. Functions of the vehicle controller 13 are implemented by cooperation of the processor 13A that executes a vehicle control program and the storage device 13B. The vehicle control program is stored in the storage device 13B. Alternatively, the vehicle control program may be recorded in a computer-readable recording medium.

The sensors 14 include a recognition sensor, a vehicle state sensor, a position sensor, and the like. The recognition sensor recognizes (detects) a situation around the vehicle 1. Examples of the recognition sensor include a camera, a laser imaging detection and ranging (LIDAR), a radar, and the like. The vehicle state sensor detects a state of the vehicle 1. Examples of the vehicle state sensor include a speed sensor, an acceleration sensor, a yaw rate sensor, a steering angle sensor, and the like. The position sensor detects a position and an orientation of the vehicle 1. Examples of the position sensor include a global navigation satellite system (GNSS) sensor, and the like.

The traveling device 15 is a device that causes the vehicle 1 to operate. The traveling device 15 includes a driving device, a braking device, and a steering device. The driving device includes, for example, at least one of an electric motor or an internal combustion for driving the vehicle 1. The braking device includes a brake actuator for braking the vehicle 1. The steering device includes an electric motor for steering wheels of the vehicle 1. The light/horn 16 includes a light and a horn. Examples of the light include a headlight, a hazard lamp, and the like.

### Management System

The management system 2 includes a communication I/F 21, one or a plurality of processors 22 (hereinafter, simply referred to as a processor 22) and one or a plurality of storage devices 23 (hereinafter, simply referred to as a storage device 23).

The communication I/F 21 is an interface for communicating with a device or a system (for example, the vehicle 1 (in-vehicle system 10), the user terminal 3, a mobile network operator) outside the management system 2 to transmit/receive information. For example, the communication I/F 21 includes various kinds of equipment such as equipment for connecting to the mobile communication network, equipment for connecting to the Internet, and equipment for connecting to a peripheral device (for example, the communication device 5 illustrated in FIG. 11B) through a wireless LAN. A configuration example of the processor 22 is the same as the configuration example of the processor 12B described above. Further, a configuration example of the storage device 23 is the same as the configuration example of the storage device 12C described above. Functions of the management system 2 are implemented by cooperation of the processor 22 that executes a management program and the storage device 23. The management program is stored in the storage device 23. Alternatively, the management program may be recorded in a computer-readable recording medium.

Various kinds of information stored in the storage device 23 include, for example, map information, vehicle information and management information. The map information includes map information of the predetermined area AR (for example, a parking lot). The map information may include a position and identification information of each landmark (marker) M arranged in the predetermined area AR. The vehicle information is information transmitted from the in-vehicle system 10 (for example, image information acquired by a camera mounted on the vehicle 1, landmark information regarding the landmark M recognized by the recognition sensor, position information of the vehicle 1). The management information is information to be used for management by the management system 2 and is, for example, vehicle management information, service information and user information. The vehicle management information is information for managing the vehicle 1 (for example, identification information (vehicle ID) of the vehicle 1, entry/check-out time information of the parking lot). The user information is information regarding the user who utilizes the vehicle 1 (for example, a user ID, service reservation information).

### Verification and Countermeasures of Suspicion of Unauthorized Activation

The management system 2 (processor 22) legitimately generates the remote instruction INS. As described above, the remote instruction includes an activation instruction INS-A that remotely activates the control device 11 (more specifically, the vehicle controller 13). Originally, the control device 11 of the vehicle 1 is scheduled to be activated in accordance with the legitimate activation instruction INS-A.

More specifically, when the power supply of the vehicle 1 is in an off state (the main power supply is turned off), the control device 11 (the communication management device 12 and the vehicle controller 13) is in a standby state. In other words, when the main power supply is in an off state, an operation mode of the control device 11 (communication management device 12) is a “normal standby mode”. The normal standby mode is a mode of waiting for receipt of the legitimate activation instruction INS-A from the management system 2. In the normal standby mode, the communication management device 12 is activated in accordance with receipt of the legitimate activation instruction INS-A. The vehicle controller 13 is configured to accept only the remote instruction INS (including the activation instruction INS-A) from the communication management device 12. The vehicle controller 13 in a standby state is activated in accordance with receipt of the legitimate activation instruction INS-A from the activated communication management device 12.

The activation instruction INS-A is not always legitimately transmitted from the management system 2 and can be transmitted by a malicious person who tries to cause the moving body to perform unauthorized operation. In other words, there is a possibility that a malicious person may falsify the activation instruction INS-A and try to activate (perform unauthorized activation of) the control device 11 by transmission of the falsified activation instruction INS-A. More specifically, the falsified activation instruction INS-A can be transmitted regardless of whether the vehicle 1 is located outside the predetermined area AR or located inside the predetermined area AR. Further, unauthorized activation of the control device 11 by a malicious person can be performed not only by the falsified (unauthorized) activation instruction INS-A (remote action) but also by direct activation operation OPE-A (non-remote action) on the control device 11 (for example, the vehicle controller 13).

On the other hand, a case is also assumed where not only a malicious person who tries to cause the moving body to perform unauthorized operation but also an unmalicious person tries to activate the control device 11, for example, using a method that is not originally scheduled or a method that causes misunderstanding. If operation of the vehicle 1 is restricted in an aspect where the restriction cannot be easily canceled for the activation instruction INS-A or the activation operation OPE-A by an unmalicious person, there is a possibility that original user convenience of the vehicle 1 may be impaired or an operation period of the vehicle 1 may decrease. The “aspect where the restriction cannot be easily canceled” described here corresponds to, for example, an aspect where the management system 2 cannot remotely cancel the operation restriction (for example, power-off of the vehicle 1) of the vehicle 1, and a staff needs to actually head to the vehicle 1 and replace a component of the vehicle 1 to cancel the operation restriction or perform special cancel operation.

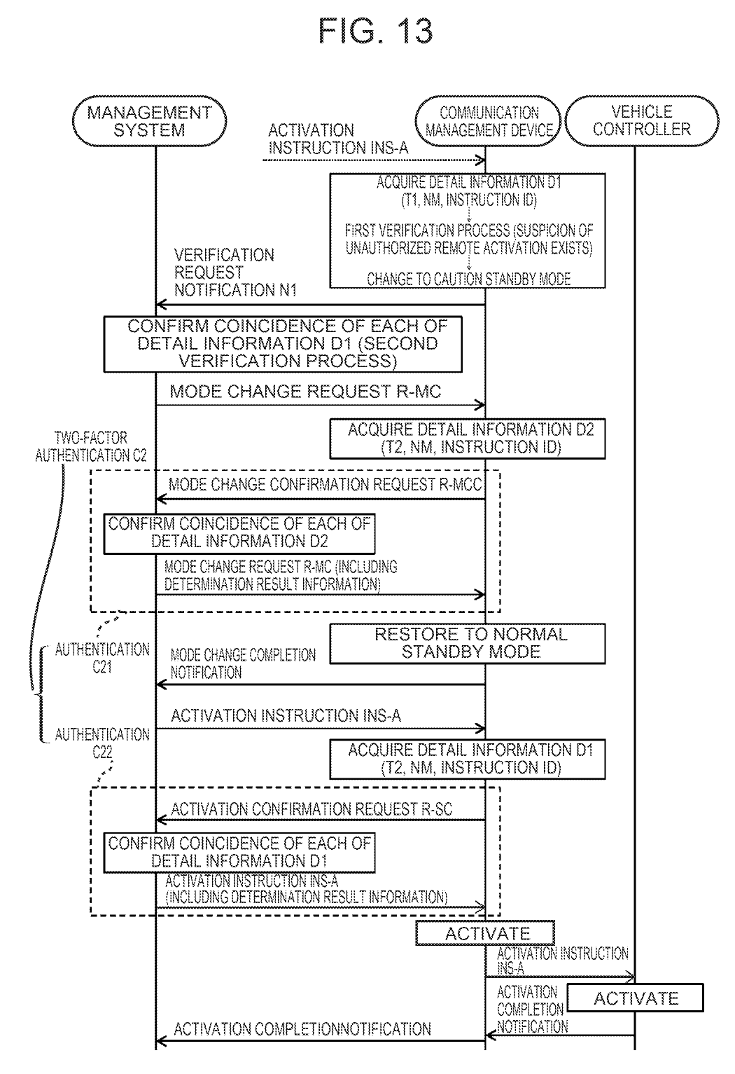

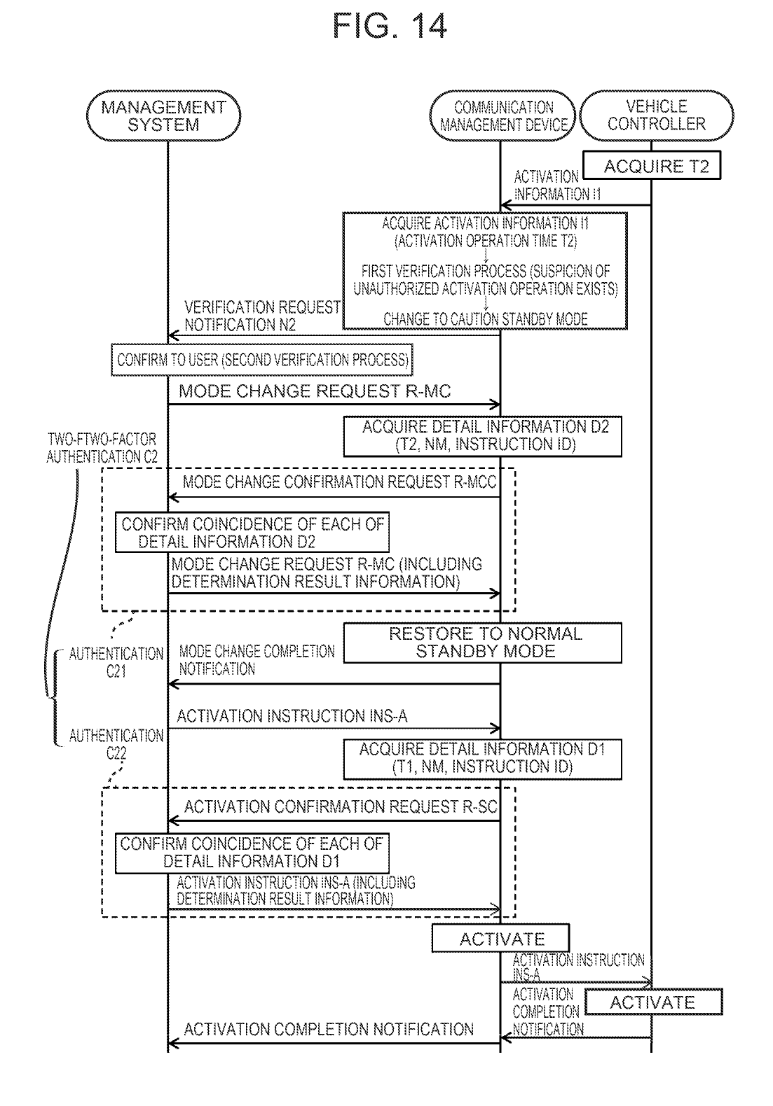

Concerning the above-described viewpoint, the vehicle control system 100 according to the present embodiment can be said to be configured as follows. In other words, the control device 11 (communication management device 12) executes a “first verification process”. The first verification process is a process of determining whether or not a suspicion of unauthorized activation (a suspicion of unauthorized remote activation or a suspicion of unauthorized activation operation) of the control device 11 (for example, the vehicle controller 13) exists. Then, when it is determined by the first verification process that the suspicion of the unauthorized activation exists, the communication management device 12 changes the operation mode of the control device 11 (communication management device 12) from the above-described normal standby mode to a “caution standby mode”. Further, when it is determined by the first verification process that the suspicion of the unauthorized activation exists, the management system 2 executes a “second verification process” for finally determining whether or not the suspicion of the unauthorized activation is valid. The caution standby mode is a mode that is to be restored to the normal standby mode under conditions that it is finally determined by the second verification process that the suspicion of the unauthorized activation is invalid and authentication between the control device 11 (communication management device 12) and the management system 2 is successful while prohibiting activation of the control device 11 (for example, the vehicle controller 13). The authentication corresponds to, for example, authentication C21 indicated in FIG. 13 and FIG. 14.

Further, determination as to whether or not the suspicion of the unauthorized activation of the control device 11 of the vehicle 1 is valid is desired to be efficiently executed by cooperation of the vehicle 1 (control device 11) and the management system 2. Concerning this viewpoint, the vehicle control system 100 according to the present embodiment can be said to be configured as follows. In other words, the control device 11 (communication management device 12) executes the above-described first verification process. Then, when the suspicion of the unauthorized activation exists, the control device 11 (communication management device 12) requests the management system 2 to execute the second verification process of finally determining whether or not the suspicion of the unauthorized activation is valid based on a criterion different from the criterion of the first verification process.

Hereinafter, a process related to “verification and countermeasures of the suspicion of the unauthorized activation” will be described in detail for each of a process on the control device (communication management device 12) side of the vehicle 1 and a process on the management system 2 side.

### Process on Control Device Side of Vehicle

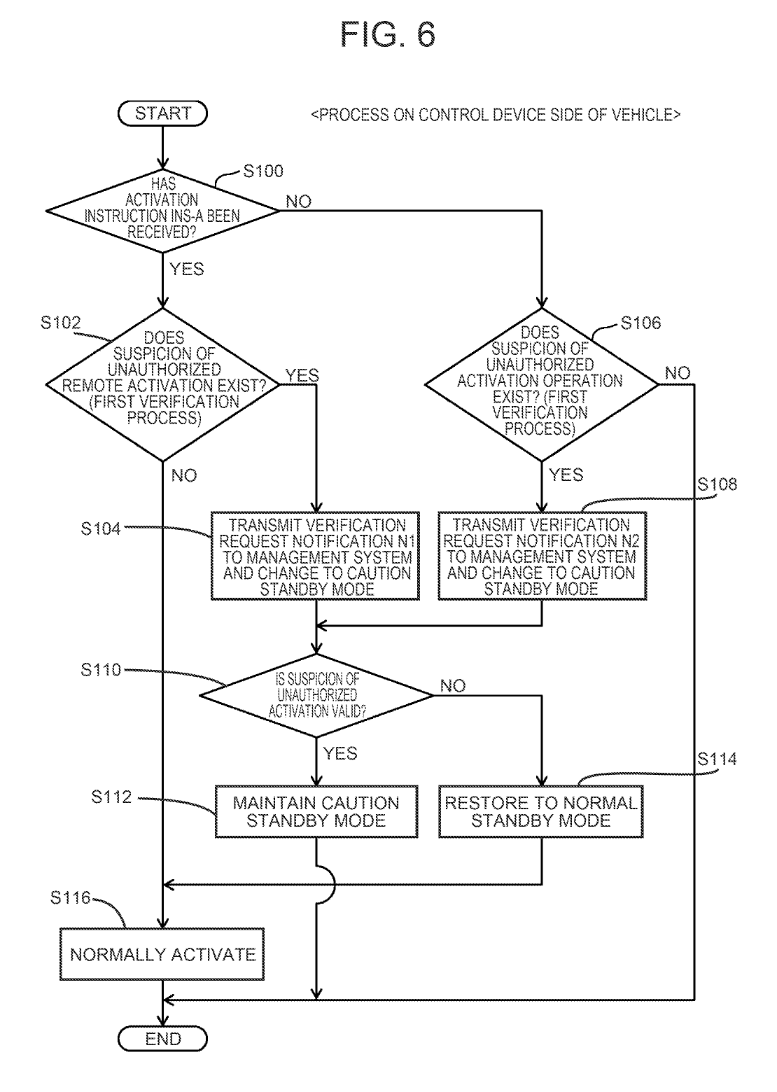

FIG. 6 is a flowchart indicating an example of the process on the vehicle 1 side related to verification and countermeasures of the suspicion of the unauthorized activation according to the present embodiment.

In step S100, the communication management device 12 (processor 12B) determines whether or not the activation instruction INS-A has been received from outside of the vehicle 1. When, as a result of the determination, the activation instruction INS-A has been received (step S100: Yes), the process proceeds to step S102.

In step S102, the communication management device 12 determines whether or not a suspicion of unauthorized activation (more specifically, a suspicion of unauthorized remote activation) based on the activation instruction INS-A received in step S100 exists. This process in step S102 corresponds to the first verification process to be performed on the activation instruction INS-A.

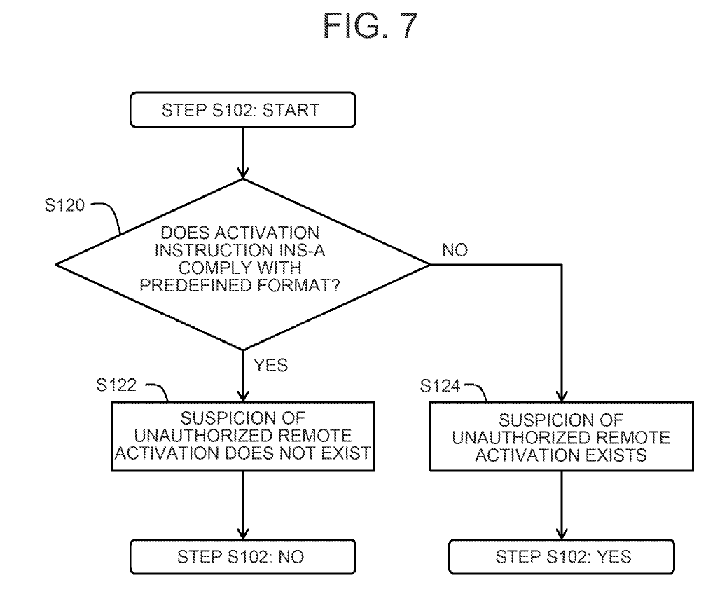

FIG. 7 is a flowchart indicating a specific example of the process of step S102 in FIG. 6. In FIG. 7, in step S120, the communication management device 12 determines whether or not the activation instruction INS-A received this time complies with the predefined format. Specifically, for example, the activation instruction INS-A may be transmitted along with a short message (text message) generated in compliance with the predefined format. This short message includes, for example, an instruction ID (symbol information that identifies the activation instruction INS-A). The predefined format in the example of the short message is, for example, the instruction ID being described at the head of the short message, a fixed number (for example, 001) having a predetermined number of digits being described at the head of the short message, or a determined number (for example, 0) being inserted between a plurality of characters or symbols included in the short message. In such an example where the short message is utilized, in step S120, the communication management device 12 determines whether or not the short message complies with the predefined format.

When the received activation instruction INS-A complies with the predefined format (step S120: Yes), the process proceeds to step S122. Then, the communication management device 12 determines that the received activation instruction INS-A is legitimate, that is, the suspicion of unauthorized remote activation does not exist. On the other hand, when the received activation instruction INS-A does not comply with the predefined format (step S120: No), the process proceeds to step S124. Then, the communication management device 12 determines that there is a possibility that the activation instruction INS-A is not legitimate, that is, the suspicion of unauthorized remote activation exists.

Further, the process of step S102 (the first verification process to be performed on the activation instruction INS-A) may include determining whether or not an electric communication number NM (for example, a phone number, an IP address) of a transmission source of the activation instruction INS-A received in step S100 coincides with an electric communication number NM1 for transmission of the activation instruction INS-A of the management system 2 grasped at the communication management device 12. Then, the communication management device 12 determines that the suspicion of unauthorized remote activation does not exist when this determination is satisfied and determines that the suspicion of unauthorized remote activation exists when the determination is not satisfied.

When the suspicion of unauthorized remote activation exists in step S102, the process proceeds to step S104. In step S104, the communication management device 12 transmits a “verification request notification N1” that requests verification of the suspicion of unauthorized remote activation based on the activation instruction INS-A of this time to the management system 2. This verification request notification N1 requests the management system 2 to execute the second verification process (step S202). As can be understood from the description which will be provided later regarding step S202, the second verification process is based on a criterion different from the criterion of the first verification process. The verification request notification N1 includes, for example, detail information D1 regarding the activation instruction INS-A of this time along with information indicating that the suspicion of unauthorized remote activation exists. The detail information D1 includes, for example, a receipt time T1 of the activation instruction INS-A by the communication management device 12, the electric communication number NM of the transmission source of the activation instruction INS-A and the instruction ID (information that identifies the activation instruction INS-A). Further, in step S104, the communication management device 12 changes the own operation mode from the normal standby mode to the caution standby mode.

On the other hand, when the activation instruction INS-A has not been received (step S100: No), the communication management device 12 determines whether or not a suspicion of unauthorized activation (more specifically, a suspicion of unauthorized activation operation) based on the activation operation OPE-A exists (step S106). This process of step S106 corresponds to the first verification process to be performed on the activation operation OPE-A.

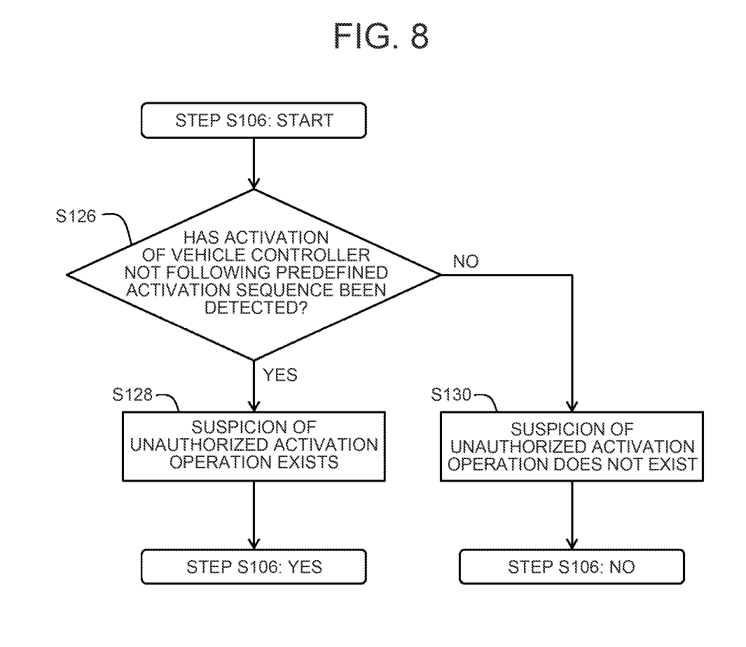

FIG. 8 is a flowchart indicating a specific example of the process of step S106 in FIG. 6. In FIG. 8, in step S126, the communication management device 12 determines whether or not activation of the control device 11 (vehicle controller 13) not following a predefined activation sequence has been detected. As described above, in the present embodiment, the communication management device 12 is activated in accordance with the legitimate activation instruction INS-A from the management system 2. Further, the vehicle controller 13 is configured to accept only the remote instruction INS (including the activation instruction INS-A) from the activated communication management device 12. In other words, the vehicle controller 13 is activated only by the activation instruction INS-A transmitted from the communication management device 12 (legitimate activation sequence).

Thus, in step S126, the communication management device 12 determines, for example, whether or not activation information I1 has been received from the vehicle controller 13, the activation information I1 indicating that the activation operation OPE-A on the vehicle controller 13 has been performed. The activation information I1 includes, for example, a time (activation operation time T3) at which the activation operation OPE-A has been performed. Then, when the activation information I1 has been received, the communication management device 12 determines that activation of the vehicle controller 13 not following the predefined activation sequence has been detected (step S126: Yes). Then, the communication management device 12 determines that there is a possibility that activation based on the activation operation OPE-A of this time may correspond to unauthorized activation, that is, may be suspected to be unauthorized activation operation (step S128). Note that when activation of the vehicle controller 13 which is suspected to be unauthorized activation operation has been detected in this manner, the communication management device 12 may transmit to the vehicle controller 13, an instruction to stop the activated vehicle controller 13 once (for example, an instruction to return the state to a standby state).

On the other hand, when information indicating that the activation operation OPE-A has been performed has not been received from the vehicle controller 13, that is, when activation of the vehicle controller 13 not following the predefined activation sequence has not been detected (step S126: No), the communication management device 12 determines that the suspicion of the unauthorized activation operation does not exist (step S130). In this case, the process indicated in FIG. 6 ends. Note that while the first verification process in step S106 is performed on the activation operation OPE-A on the vehicle controller 13 here, the first verification process may be executed in a similar manner also on the activation operation OPE-A performed on the communication management device 12.

When the suspicion of the unauthorized activation operation exists in step S106, the process proceeds to step S108. In step S108, the communication management device 12 transmits a “verification request notification N2” that requests verification of the suspicion of the unauthorized activation operation based on the activation operation OPE-A of this time to the management system 2. This verification request notification N2 also requests the management system 2 to execute the second verification process (step S210). As can be understood from the description regarding step S210 which will be described later, the second verification process is also based on a criterion different from the criterion of the first verification process. The verification request notification N2 includes, for example, the activation information I1 as detail information regarding the activation operation OPE-A of this time along with information indicating that the suspicion of the unauthorized activation operation exists. The activation information I1 includes, for example, the activation operation time T3 described above. Further, in step S108, the communication management device 12 changes the own operation mode from the normal standby mode to the caution standby mode.

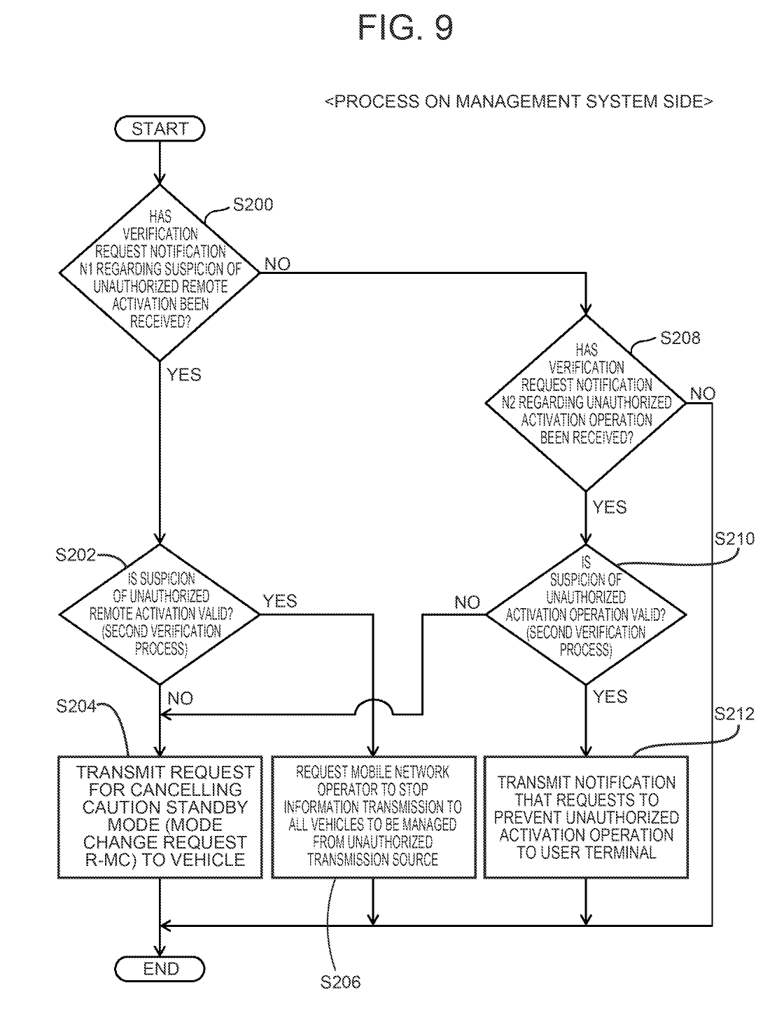

In step S110 subsequent to step S104 or S108, the communication management device 12 acquires a final determination result (a result of the second verification process indicated in FIG. 9) of the management system 2 regarding the suspicion of the unauthorized activation of this time (a suspicion of unauthorized remote activation or a suspicion of unauthorized activation operation) from the management system 2. Then, the communication management device 12 determines the acquired final determination result (whether the suspicion of the unauthorized activation is valid or invalid).

When the suspicion of the unauthorized activation is valid (step S110: Yes), the communication management device 12 maintains the caution standby mode (step S112). On the other hand, when the suspicion of the unauthorized activation is invalid (step S110: No), the communication management device 12 restores the own operation mode from the caution standby mode to the normal standby mode in accordance with a mode change request R-MC received from the management system 2 (step S114). Note that a specific example of processing flow related to restoration from the caution standby mode to the normal standby mode will be described later with reference to FIG. 13 and FIG. 14.

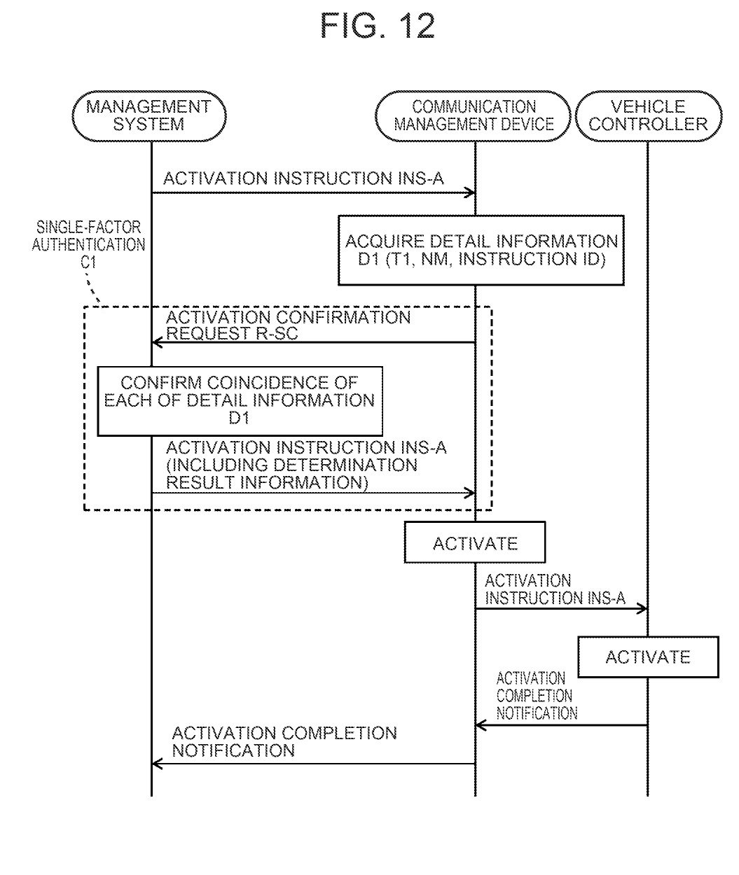

When it is determined in step S102 that the suspicion of unauthorized remote activation does not exist or after step S114, the communication management device 12 executes a process regarding normal activation of the vehicle controller 13. Specifically, as will be describe later in detail with reference to FIG. 12 to FIG. 14, the communication management device 12 activates the vehicle controller 13 under conditions that single-factor authentication C1 (= authentication C22) is completed.

### Process on Management System Side

FIG. 9 is a flowchart indicating an example of a process on the management system 2 side related to verification and countermeasures of the suspicion of the unauthorized activation according to the present embodiment.

In step S200, the management system 2 (processor 22) determines whether or not the verification request notification N1 regarding the suspicion of unauthorized remote activation has been received from the vehicle 1. When the verification request notification N1 has been received as a result of the determination (step S200: Yes), the management system 2 executes the second verification process (step S202). In other words, the management system 2 finally determines whether or not the suspicion of unauthorized remote activation related to the verification request notification N1 is valid. In addition, the management system 2 transmits the final determination result as to whether or not the suspicion of unauthorized remote activation is valid to the vehicle 1.

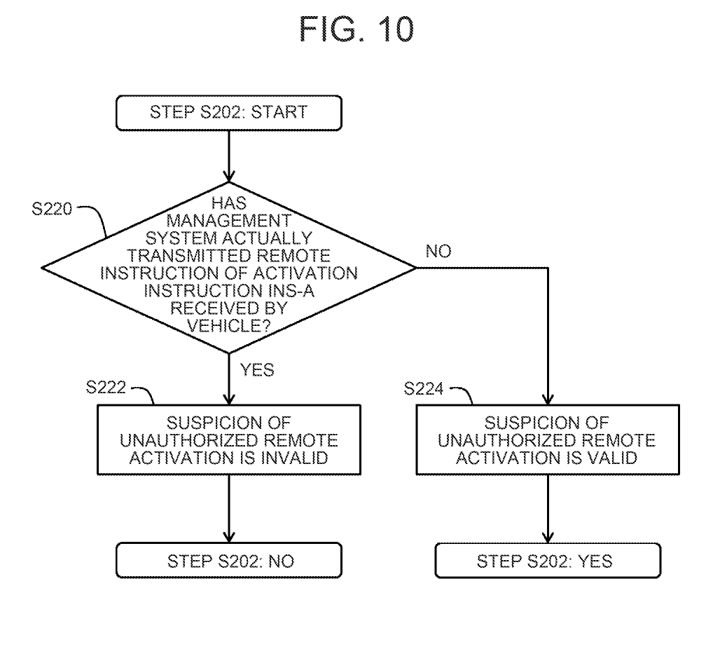

FIG. 10 is a flowchart indicating a first specific example (issuer verification process) of the second verification process (step S202) to be performed on the suspicion of unauthorized remote activation. In FIG. 10, in step S220, the management system 2 determines whether or not the management system 2 has actually transmitted the activation instruction INS-A of this time received by the vehicle 1. Specifically, the management system 2 reads transmission history of the own activation instruction INS-A from the storage device 23 and checks the detail information D1 described above included in the verification request notification N1 against the transmission history. For example, the management system 2 checks each of the receipt time T1 of the activation instruction INS-A and the electric communication number NM of the transmission source included in the detail information D1 against the transmission history. Alternatively, as in the example indicated in FIG. 13 described later, the management system 2 may check an instruction ID against the transmission history along with the receipt time T1 and the electric communication number NM of the transmission source.

When each of the receipt time T1 and the electric communication number NM of the transmission source coincides with information included in the transmission history as a result of the check, the management system 2 determines that the management system 2 has actually transmitted the activation instruction INS-A of this time (step S220: Yes). Then, the management system 2 finally determines that the suspicion of unauthorized remote activation of this time is invalid (step S222).

In addition, even when it is determined by the communication management device 12 that the suspicion of unauthorized remote activation exists (step S102: Yes), there is also a case where it can be said that the activation instruction INS-A has been transmitted by an unmalicious person. Transmission of the activation instruction INS-A by an unmalicious person corresponds to, for example, transmission performed under the condition that while a terminal that transmits the activation instruction INS-A has been changed on the management system 2 side, information of the change is not shared between the management system 2 and the vehicle 1. As another example, transmission by an unmalicious person corresponds to transmission under the condition that a version of the predefined format (see step S120) to be utilized upon transmission/reception of the activation instruction INS-A between the management system 2 and the vehicle 1 is not the same between the management system 2 and the vehicle 1.

On the other hand, when each of the receipt time T1 and the electric communication number NM of the transmission source does not coincide with the information included in the transmission history, the management system 2 determines that the management system 2 has not actually transmitted the activation instruction INS-A (step S220: No). As a result, the management system 2 finally determines that the suspicion of unauthorized remote activation is valid (step S224). According to the issuer verification process described above, it is possible to prevent the vehicle 1 from being taken over by a person who performs unauthorized transmission of the activation instruction INS-A regardless of whether or not the vehicle 1 is located inside or outside the predetermined area AR.

When it is finally determined that the suspicion of unauthorized remote activation of this time is invalid (step S202: No), the process proceeds to step S204. In step S204, the management system 2 transmits a request for canceling the caution standby mode, that is, the mode change request R-MC from the caution standby mode to the normal standby mode to the vehicle 1. Note that a specific example of specific processing flow related to the mode change request R-MC will be described later with reference to FIG. 13.

On the other hand, when it is finally determined that the suspicion of unauthorized remote activation of this time is valid (step S202: Yes), the process proceeds to step S206. In step S206, the management system 2 communicates with a mobile network operator that provides a mobile communication service to a plurality of vehicles 1 (including the vehicle 1 on which the process indicated in FIG. 9 is to be performed) managed by the management system 2. Then, the management system 2 requests the mobile network operator to stop information transmission from an electric communication number NM-X (unauthorized transmission source) used for transmission of the activation instruction INS-A related to the suspicion of unauthorized remote activation of this time. Targets to which the information transmission (for example, transmission of a short message) is to be stopped are all the vehicles 1 managed by the management system 2 and are specified, for example, based on vehicle management information stored in the storage device 23. Then, stop of the information transmission is performed under conditions that the following transmission stop condition is satisfied.

The above-described transmission stop condition is, for example, a condition that the electric communication number NM-X has been used for the unauthorized activation instruction INS-A of the control devices 11 of a plurality of vehicles 1 including the control device 11 of the vehicle 1 on which the process indicated in FIG. 9 is to be performed. Alternatively, the transmission stop condition is, for example, a condition that the electric communication number NM-X has been used a plurality of times within a predetermined period for the unauthorized activation instruction INS-A of the control device 11 of the vehicle 1 on which the process indicated in FIG. 9 is to be performed. In addition, for example, the management system 2 stores a list of information of the electric communication numbers NM of transmission sources included in the detail information D1 received from the respective vehicles 1 to be managed in the storage device 23. Then, the management system 2 determines whether or not the above-described transmission stop condition is satisfied based on such information of the list. According to the process of step S206 described above, it is possible to efficiently prevent the unauthorized activation instruction INS-A from being transmitted to all the vehicles 1 to be managed by the management system 2 from the detected unauthorized transmission source of this time.

On the other hand, when the verification request notification N1 has not been received (step S200: No), the management system 2 determines whether or not the verification request notification N2 regarding the suspicion of the unauthorized activation operation has been received from the vehicle 1. When the verification request notification N2 has not been received as a result of the determination (step S208: No), the process indicated in FIG. 9 ends.

When the verification request notification N2 has been received (step S208: Yes), the management system 2 executes the second verification process (step S210). In other words, the management system 2 finally determines whether or not the suspicion of the unauthorized activation operation related to the verification request notification N2 is valid. In addition, the management system 2 transmits a final determination result as to whether or not the suspicion of the unauthorized activation operation is valid to the vehicle 1.

The second verification process in the present step S210 includes, for example, a process of making a notification INQ that inquires about activation of the vehicle controller 13 to a user of the vehicle 1 (for example, a current borrower, an owner). More specifically, the management system 2 transmits the notification INQ (for example, a short message) including an inquiry item for the activation of the vehicle controller 13 to the user terminal 3 operated by the user. For example, the inquiry item may include a message that confirms to the user whether or not the user has erroneously activated the vehicle controller 13 around the activation operation time T3 (see step S126). Alternatively, for example, the inquiry item may include a message that confirms to the user whether or not the user knows something about the activation of the vehicle controller 13 around the activation operation time T3 and a message that, when the user knows something about the activation, confirms to the user a reason why the vehicle controller 13 has been activated.

When, for example, a response indicating that the user knows something about the activation of the vehicle controller 13 and the reason why the vehicle controller 13 has been activated is appropriate, has been received from the user via the user terminal 3 in response to the inquiry by the above-described notification INQ, the management system 2 finally determines that the suspicion of the unauthorized activation operation of this time is invalid (step S210: No). In addition, the appropriate reason regarding the activation of the vehicle controller 13 corresponds to, for example, a case where the user has requested repair of the vehicle 1 to a repair worker, a worker has activated the vehicle controller 13 by erroneously depressing a power button during repair of the vehicle 1. Alternatively, another appropriate reason corresponds to a case where the user of the vehicle 1 has activated the vehicle controller 13 by erroneously depressing the power button. In addition, activation by such a reason can be said as activation of the control device 11 (vehicle controller 13) by an unmalicious person.

When the suspicion of the unauthorized activation operation is invalid (step S210: No), the management system 2 transmits a request for canceling the caution standby mode, that is, the mode change request R-MC to the vehicle 1 (step S204).

On the other hand, when, for example, a response indicating that the user knows nothing about the activation of the vehicle controller 13 or a response indicating that the user knows something about the activation but the reason why the vehicle controller 13 has been activated is not appropriate, has been received from the user via the user terminal 3 in response to the above-described notification INQ, the management system 2 finally determines that the suspicion of the unauthorized activation operation is valid (step S210: Yes).

When the suspicion of the unauthorized activation operation is valid (step S210: Yes), the management system 2, for example, transmits a notification that requests to prevent the unauthorized activation operation to the user terminal 3. The notification corresponds to, for example, a notification that requests the user (borrower of the vehicle 1) not to try activation using an unauthorized method.

### Second Specific Example of Second Verification Process

Here, the following first to third examples of an area verification process will be described as a second specific example of the second verification process (step S202) to be performed on the suspicion of unauthorized remote activation.

Basically, the management system 2 transmits the activation instruction INS-A to the vehicle 1 when the vehicle 1 is located in the predetermined area AR. When the vehicle 1 is located outside the predetermined area AR, the management system 2 does not transmit the activation instruction INS-A to the vehicle 1. For example, while the AVP vehicle 1A (see FIG. 3) that supports the automated valet parking operates in accordance with the remote instruction INS including the activation instruction INS-A in the parking lot, the AVP vehicle 1A is driven by the user outside the parking lot. The AVP vehicle 1A does not receive the activation instruction INS-A from the management system 2 outside the parking lot. If the vehicle 1 receives the activation instruction INS-A when the vehicle 1 is located outside the predetermined area AR, there is a high possibility that the activation instruction INS-A is not a legitimate instruction transmitted from the management system 2 and is suspected to be unauthorized remote activation.

From the viewpoint described above, as the second specific example of the second verification process, it is considered to determine whether or not the vehicle 1 is present in the predetermined area AR when the vehicle 1 receives the activation instruction INS-A. A process of determining whether or not the vehicle 1 is present in the predetermined area AR when the vehicle 1 receives the activation instruction INS-A is an “area verification process” described here. FIG. 11A is a conceptual diagram for explaining the first to the third examples of the area verification process.

The first example of the area verification process is determination as to whether or not the landmark M arranged in the predetermined area AR is recognizable from the position of the vehicle 1. When the landmark M is not recognizable from the position of the vehicle 1, the management system 2 finally determines that the vehicle 1 is not present in the predetermined area AR when the control device 11 (communication management device 12) receives the activation instruction INS-A, and the suspicion of unauthorized remote activation is valid.

More specifically, the vehicle 1 (in-vehicle system 10) transmits image information acquired by the camera mounted on the vehicle 1 to the management system 2. The management system 2 is configured to recognize the landmark M around the vehicle 1 based on the image information received from the vehicle 1. The management system 2 determines whether the landmark M around the vehicle 1 is recognized. When the landmark M is not recognized, the management system 2 determines that the landmark M is not recognizable from the position of the vehicle 1. In other words, the management system 2 determines that the vehicle 1 is not present in the predetermined area AR when the communication management device 12 receives the activation instruction INS-A.

The second example of the area verification processing is comparison between the position information of the vehicle 1 and the map information. In the map information, a position of the predetermined area AR is registered. Thus, by comparing the position information of the vehicle 1 and the map information, the management system 2 determines whether or not the vehicle 1 is present in the predetermined area AR when the control device 11 (communication management device 12) receives the activation instruction INS-A. Then, when the vehicle 1 is not present in the predetermined area AR when the communication management device 12 receives the activation instruction INS-A, the management system 2 finally determines that the suspicion of unauthorized remote activation is valid.

More specifically, the in-vehicle system 10 acquires the position information of the vehicle 1 using the position sensor included in the sensors 14. Alternatively, the in-vehicle system 10 acquires the position information of the vehicle 1 through the localization process. The in-vehicle system 10 transmits the position information of the vehicle 1 to the management system 2. The management system 2 acquires the position information of the vehicle 1 from the in-vehicle system 10. Then, the management system 2 determines whether or not the vehicle 1 is present in the predetermined area AR when the communication management device 12 receives the activation instruction INS-A by comparing the position information of the vehicle 1 and the map information.

In the third example of the area verification process, the vehicle 1 (in-vehicle system 10) and the communication device 5 provided in the predetermined area AR are configured to perform communication in accordance with a specific communication scheme. For example, in a case of the automated valet parking illustrated in FIG. 3, the parking lot control center 2B corresponds to the communication device 5, and the AVP vehicle 1A in the parking lot and the parking lot control center 2B perform communication in accordance with the specific communication scheme. The specific communication scheme is, for example, a near field communication scheme such as WiFi (registered trademark) and Bluetooth (registered trademark).

The third example is determination as to whether or not communication is established between the vehicle 1 (in-vehicle system 10) and the communication device 5 provided in the predetermined area AR. When communication is not established between the vehicle 1 and the communication device 5, the management system 2 finally determines that the vehicle 1 is not present in the predetermined area AR when the communication management device 12 receives the activation instruction INS-A and the suspicion of unauthorized remote activation is valid.

FIG. 11B is a flowchart indicating outline of the first to the third examples of the area verification process. In FIG. 11B, in step S230, the management system 2 determines whether or not the vehicle 1 is present in the predetermined area AR. When the vehicle 1 is present in the predetermined area AR (step S230: Yes), the management system 2 finally determines that the suspicion of unauthorized remote activation of this time is invalid (step S232). On the other hand, when the vehicle 1 is not present in the predetermined area AR (step S230: No), the management system 2 finally determines that the suspicion of unauthorized remote activation is valid (step S234).

According to the area verification process described above, it is possible to prevent the vehicle 1 located outside the predetermined area AR from being taken over by a person who tries to perform unauthorized transmission of the activation instruction INS-A.

### Specific Examples of Processing Flow Related to Activation of Control Device

Here, three specific examples regarding processing flow related to activation of the control device 11 (the communication management device 12 and the vehicle controller 13) of the vehicle 1 will be described.

First, FIG. 12 is a sequence diagram indicating a specific example of the processing flow related to activation of the control device 11 based on the legitimate activation instruction INS-A. FIG. 12 indicates an example where the legitimate activation instruction INS-A is transmitted from the management system 2 to the communication management device 12 in the normal standby mode.

The communication management device 12 acquires the detail information D1 (for example, the receipt time T1, the electric communication number NM of the transmission source, and the instruction ID) regarding the activation instruction INS-A1 received this time and stores the detail information D1 in the storage device 12C. As in the example indicated in FIG. 12, if the activation instruction INS-A transmitted from the management system 2 is legitimate, it is not determined by the first verification process that the activation instruction INS-A is suspected to be unauthorized remote activation. Thus, the communication management device 12 executes a process for normal authentication (single-factor authentication C1).

The single-factor authentication C1 is executed to confirm that the activation instruction INS-A received by the communication management device 12 has been actually transmitted from the management system 2. As the processing content, the process of the single-factor authentication C1 is similar to the above-described issuer verification process (see FIG. 10). Specifically, in the single-factor authentication C1, the communication management device 12 transmits an activation confirmation request R-SC accompanied by the detail information D1 to the management system 2.

The management system 2 that has received the activation confirmation request R-SC executes a process of responding to the activation confirmation request R-SC as follows. For example, the management system 2 determines whether or not the receipt time T1 received from the communication management device 12 is consistent with a time at which the management system 2 has transmitted the activation instruction INS-A. Further, the management system 2 determines whether or not the electric communication number NM of the transmission source received from the communication management device 12 coincides with the electric communication number NM1 utilized by the management system 2 to transmit the activation instruction INS-A. Further, the management system 2 determines whether or not the instruction ID received from the communication management device 12 coincides with an instruction ID1 of the activation instruction INS-A by the management system 2. In the example indicated in FIG. 12, the activation instruction INS-A is legitimate, and thus, all of these three kinds of determination are satisfied. In this case, the management system 2 transmits the activation instruction INS-A accompanied by positive determination result information regarding the three kinds of determination to the communication management device 12 again.

If the communication management device 12 receives the activation instruction INS-A accompanied by the positive determination result information, the single-factor authentication C1 is completed. In association with this, the communication management device 12 cancels the normal standby mode, and the state transitions to an active state. Then, the communication management device 12 transmits the activation instruction INS-A to the vehicle controller 13 in a standby state. The vehicle controller 13 is activated in accordance with receipt of the activation instruction INS-A from the communication management device 12. Then, the vehicle controller 13 transmits an activation completion notification indicating that the activation of the vehicle controller 13 has been completed to the communication management device 12. The communication management device 12 that has received the activation completion notification transmits the activation completion notification to the management system 2.

Then, FIG. 13 is a sequence diagram indicating a specific example of the processing flow related to activation of the control device 11 when the activation instruction INS-A that is suspected to be unauthorized remote activation has been received. In addition, FIG. 13 corresponds to an example where it is finally determined by the second verification process that the suspicion of unauthorized remote activation is invalid.

The communication management device 12 executes the first verification process (see step S102 in FIG. 6) after acquiring the detail information D1 regarding the activation instruction INS-A received this time. In the example indicated in FIG. 13, it is determined by the first verification process that the suspicion of unauthorized remote activation exists. Thus, the communication management device 12 changes the own operation mode from the normal standby mode to the caution standby mode and transmits the verification request notification N1 to the management system 2 (see step S104).

The management system 2 that has received the verification request notification N1 executes the second verification process (for example, the issuer verification process indicated in FIG. 10) (see step S202). As described above, in FIG. 13, it is finally determined by the second verification process that the suspicion of unauthorized remote activation is invalid. Thus, the management system 2 transmits the mode change request R-MC to the vehicle 1 (communication management device 12) (see step S204).

The communication management device 12 that has received the mode change request R-MC executes a process for two-factor authentication C2. This two-factor authentication C2 includes authentication C21 and authentication C22 following authentication C21. The authentication C21 is executed to confirm that the mode change request R-MC received by the communication management device 12 has been actually transmitted from the management system 2. Processing content of the authentication C22 is the same as the processing content of the single-factor authentication C1.

In the authentication C21, the communication management device 12 acquires detail information D2 (for example, a receipt time T2 of the mode change request R-MC, the electric communication number NM of the transmission source, and the instruction ID) regarding the mode change request R-MC received this time and stores the detail information D2 in the storage device 12C. Then, the communication management device 12 transmits a mode change confirmation request R-MCC accompanied by the detail information D2 to the management system 2.

The management system 2 that has received the mode change confirmation request R-MCC executes a process of responding to the mode change confirmation request R-MCC. This process of responding to the mode change confirmation request R-MCC is, for example, executed in a similar manner to the process of responding to the activation confirmation request R-SC described with reference to FIG. 12. If positive determination result information regarding the three kinds of determination included in the detail information D2 is obtained as a result, the management system 2 transmits the mode change request R-MC accompanied by the positive determination result information to the communication management device 12 again.

If the communication management device 12 receives the mode change request R-MC accompanied by the positive determination result information, the authentication C21 is completed. In association with this, the communication management device 12 executes restoration from the caution standby mode to the normal standby mode. Then, the communication management device 12 transmits a mode change completion notification indicating completion of the mode change to the management system 2.

The management system 2 that has received the mode change completion notification transmits the legitimate activation instruction INS-A to the communication management device 12. The communication management device 12 that has received the legitimate activation instruction INS-A executes the authentication C22 in a similar manner to the single-factor authentication C1. If the authentication C22 is completed as a result, the two-factor authentication C2 is completed, and the communication management device 12 and the vehicle controller 13 are sequentially activated. In other words, the control device 11 is configured to be activated after the authentication C21 is completed, and then, the authentication C22 is completed, and the authentication C21 is authentication regarding mode change, and the authentication C22 is authentication regarding activation of the control device 11.

In addition, as described above, in the vehicle control system 100, completion of the two-factor authentication C2 is required to activate the control device 11 after it is finally determined in the second verification process that the suspicion of unauthorized remote activation (the similar is applied to the suspicion of the unauthorized activation operation indicated in FIG. 14) is invalid. In other words, the control device 11 is prevented from being activated without the two-factor authentication C2 being completed.

Next, FIG. 14 is a sequence diagram indicating a specific example of the processing flow related to activation of the control device 11 when the activation instruction INS-A that is suspected to be unauthorized activation operation has been received. In addition, FIG. 14 corresponds to an example where it is finally determined by the second verification process that the suspicion of the unauthorized activation operation is invalid.

When the activation operation OPE-A is performed on the vehicle controller 13, the vehicle controller 13 acquires the activation information I1 including the activation operation time T3 regarding the activation operation OPE-A and stores the activation information I1 in the storage device 13B of the vehicle controller 13. Then, the vehicle controller 13 transmits the activation information I1 to the communication management device 12.

The communication management device 12 that has received the activation information I1 stores the activation information I1 in the storage device 12C and executes the first verification process (see step S106). When the activation information I1 is received from the vehicle controller 13, it is determined by the first verification process that the suspicion of unauthorized remote activation exists. Thus, the communication management device 12 changes the operation mode from the normal standby mode to the caution standby mode and transmits the verification request notification N2 to the management system 2 (see step S108).

The management system 2 that has received the verification request notification N2 executes the second verification process (see step S210). As described above, in FIG. 14, it is finally determined by the second verification process that the suspicion of the unauthorized activation operation is invalid. Thus, the management system 2 transmits the mode change request R-MC to the vehicle 1 (communication management device 12) (see step S204).

Even when the mode change request R-MC is received after it is determined that the suspicion of the unauthorized activation operation exists as in the specific example indicated in FIG. 14, the communication management device 12 executes the process of the two-factor authentication C2. The processing flow thereafter is similar to that described with reference to FIG. 13, and thus, detailed description will be omitted.

Note that while the processing flow in accordance with the activation operation OPE-A on the vehicle controller 13 has been described with reference to FIG. 14, the processing flow is similar also when the activation operation OPE-A on the communication management device 12 has been detected.

### Modification of Process on Control Device Side of Vehicle

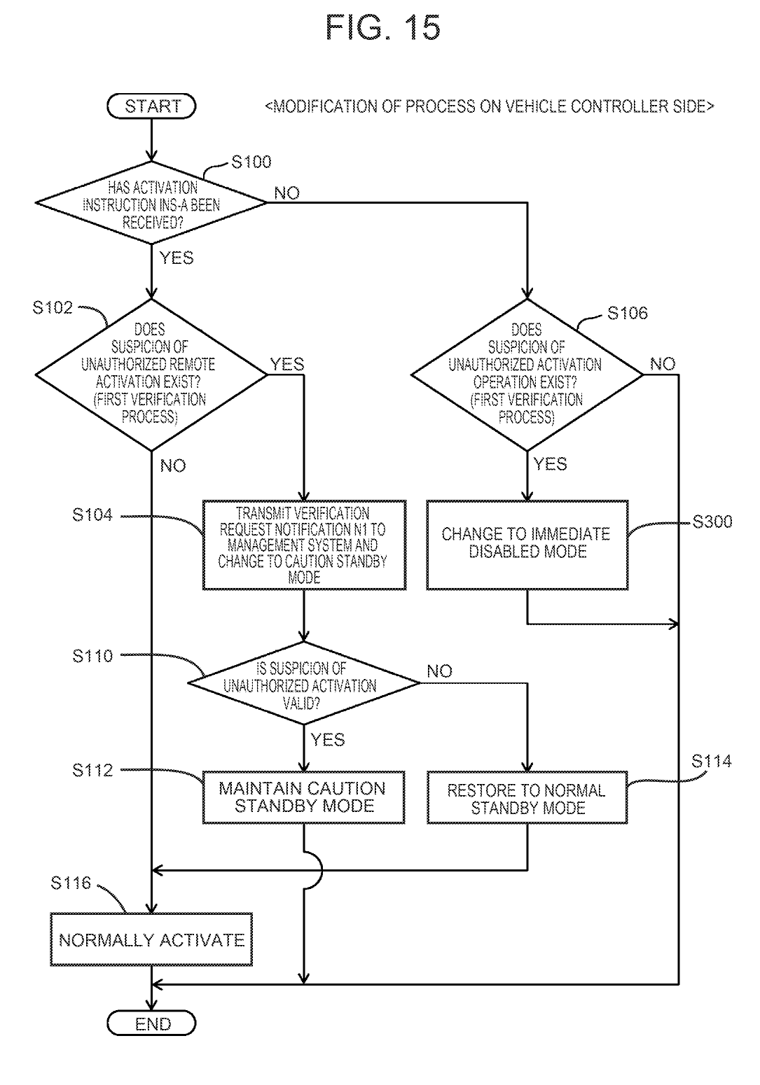

FIG. 15 is a flowchart indicating a modification of a process on the vehicle 1 side related to verification and countermeasures of the suspicion of the unauthorized activation according to the present embodiment. The process of this flowchart differs from the process of the flowchart indicated in FIG. 6 in that the following process of step S300 is executed instead of step S108.

In a similar manner to FIG. 6, the first verification process in FIG. 15 includes a process (step S102) of determining whether or not a suspicion of unauthorized remote activation exists and a process (step S106) of determining whether or not a suspicion of unauthorized activation operation exists. It can be therefore said that the first verification process in FIG. 15 includes determination as to which of a suspicion of unauthorized remote activation or a suspicion of unauthorized activation operation, the suspicion of unauthorized activation is. Then, in FIG. 15, when the suspicion of the unauthorized activation operation exists in step S106, the communication management device 12 changes the own operation mode to an “immediate disabled mode” instead of the caution standby mode.

The immediate disabled mode described here is a mode of disabling activation of the control device 11 in an aspect where the management system 2 cannot remotely cancel an activation disabled state of the control device 11. More specifically, a target for which activation is to be disabled is at least the vehicle controller 13 between the vehicle controller 13 and the communication management device 12. Further, the “aspect where the management system 2 cannot remotely cancel the activation disabled state of the control device 11” is, for example, an aspect where a staff needs to replace a component of the vehicle 1 to cancel the activation disabled state or an aspect where a staff needs to perform special cancellation operation on the control device 11.

Note that when the process on the control device 11 side is executed as indicated in FIG. 15, the process on the management system 2 side is the process obtained by omitting the processes from step S208 to S212 from the processes of the flowchart indicated in FIG. 9.

### Effects

As described above, according to the present embodiment, when it is determined on the vehicle 1 side that the suspicion of the unauthorized activation of the control device 11 exists, by the mode transitioning to the caution standby mode, it is possible to wait for final determination by the management system 2 as to whether or not the suspicion of the unauthorized activation exists while preventing the control device 11 from being utilized to cause the vehicle 1 to perform unauthorized operation. Then, the operation mode of the control device 11 (communication management device 12) is restored from the caution standby mode to the normal standby mode under conditions that it is finally determined by the second verification process that the suspicion of the unauthorized activation is invalid, and authentication (for example, the authentication C21) between the control device 11 and the management system 2 is successful. This prevents execution of unnecessary or excessive operation restriction of the vehicle 1. This leads to prevention of abuse of functions of the vehicle 1 while preventing degradation of user convenience or decrease in the operation period of the vehicle 1.

Further, as described above, according to the present embodiment, only when it is determined on the vehicle 1 side that the suspicion of the unauthorized activation exists, the control device 11 (communication management device 12) of the vehicle 1 requests the management system 2 to execute the second verification process of finally determining whether or not the suspicion of the unauthorized activation is valid based on the criterion different from the criterion of the first verification process. This makes it possible for the vehicle 1 (in-vehicle system 10) and the management system 2 to cooperate to efficiently execute determination as to whether or not the suspicion of the unauthorized activation of the vehicle 1 is valid.

Further, as described with reference to FIG. 6, FIG. 9, FIG. 13 and FIG. 14, according to the present embodiment, when it is finally determined in the second verification process that the suspicion of the unauthorized activation is invalid, the operation mode of the control device 11 (communication management device 12) is restored from the caution standby mode to the normal standby mode under conditions that the authentication C21 is completed. In this manner, even under the condition that the suspicion of unauthorized remote activation exists, as a result of the management system 2 and the control device 11 cooperating, the control device 11 can be restored to a state (that is, the normal standby mode) in which the management system 2 can remotely activate the control device 11 by utilizing the legitimate activation instruction INS-A.

Further, according to the process described above with reference to FIG. 15, it is possible to implement countermeasures against abuse of the functions of the vehicle 1 in view of preventing degradation of user convenience or decrease in the operation period of the vehicle 1, while reliably preventing abuse of the functions of the vehicle 1 by direct unauthorized activation operation on the vehicle 1.

What is claimed is:

1. A moving body control system configured to control a moving body having a function of operating in accordance with a remote instruction in a predetermined area, the moving body control system comprising:
a management system configured to legitimately generate the remote instruction; and
a control device mounted on the moving body and configured to cause the moving body to operate in accordance with the legitimate remote instruction from the management system,
wherein the control device is configured to
execute a first verification process of determining whether or not a suspicion of unauthorized activation of the control device exists, and
when the suspicion of the unauthorized activation exists, request the management system to execute a second verification process of finally determining whether or not the suspicion of the unauthorized activation is valid based on a criterion different from a criterion of the first verification process.

2. The moving body control system according to claim 1, wherein:
the remote instruction includes an activation instruction that remotely activates the control device; and
the first verification process includes
determining whether or not the activation instruction received by the control device complies with a predefined format, and
when the activation instruction does not comply with the predefined format, determining that the suspicion of the unauthorized activation exists.

3. The moving body control system according to claim 1, wherein the first verification process includes:
determining whether or not activation of the control device not following a predefined activation sequence has been detected; and
when the activation of the control device not following the predefined activation sequence has been detected, determining that the suspicion of the unauthorized activation exists.

4. The moving body control system according to claim 1, wherein:
the remote instruction includes an activation instruction that remotely activates the control device; and
the second verification process includes
determining whether or not the management system has actually transmitted the activation instruction received by the moving body, and
when the management system has not actually transmitted the activation instruction to the moving body, finally determining that the suspicion of the unauthorized activation is valid.

5. The moving body control system according to claim 4, wherein:
when the second verification process finally determines that the suspicion of the unauthorized activation is valid, the management system is configured to request a mobile network operator to stop information transmission to all moving bodies managed by the management system from an electric communication number used for transmission of the activation instruction related to the suspicion of the unauthorized activation under conditions that a transmission stop condition is satisfied; and
the transmission stop condition is
a condition that the electric communication number has been used for an unauthorized activation instruction of control devices of a plurality of moving bodies including the control device of the moving body, or
a condition that the electric communication number has been used a plurality of times within a predetermined period for an unauthorized activation instruction of the control device of the moving body.

6. The moving body control system according to claim 1, wherein:
the remote instruction includes an activation instruction that remotely activates the control device;
a landmark is arranged in the predetermined area; and
the second verification process includes
determining whether or not the landmark is recognizable from a position of the moving body, and
when the landmark is not recognizable from the position of the moving body, finally determining that the moving body is not present in the predetermined area when the control device receives the activation instruction and the suspicion of the unauthorized activation is valid.

7. The moving body control system according to claim 1, wherein:
the remote instruction includes an activation instruction that remotely activates the control device; and
the second verification process includes
acquiring position information of the moving body,
determining whether or not the moving body is present in the predetermined area when the control device receives the activation instruction by comparing map information in which a position of the predetermined area is registered and the position information of the moving body, and
when the moving body is not present in the predetermined area when the control device receives the activation instruction, finally determining that the suspicion of the unauthorized activation is valid.

8. The moving body control system according to claim 1, wherein:
the remote instruction includes an activation instruction that remotely activates the control device;
the moving body and a communication device provided in the predetermined area are configured to perform communication in accordance with a specific communication scheme; and
the second verification process includes
determining whether or not communication is established between the moving body and the communication device, and
when the communication is not established between the moving body and the communication device, finally determining that the moving body is not present in the predetermined area when the moving body receives the activation instruction and the suspicion of the unauthorized activation is valid.

9. The moving body control system according to claim 1, wherein:
the control device is configured to be activated after first authentication is completed, and then, second authentication is completed; and
the first authentication is authentication regarding mode change, and the second authentication is authentication regarding activation of the control device.

10. A moving body control method for controlling a moving body having a function of operating in accordance with a remote instruction in a predetermined area, the moving body control method comprising:
causing a control device to execute a first verification process of determining whether or not a suspicion of unauthorized activation of the control device exists; and
when the suspicion of the unauthorized activation exists, requesting a management system to execute a second verification process of finally determining whether or not the suspicion of the unauthorized activation is valid based on a criterion different from a criterion of the first verification process,
wherein the control device configured to cause the moving body to operate in accordance with a legitimate remote instruction from the management system configured to legitimately generate the remote instruction is mounted on the moving body.
